(19) United States
(12) Patent Application Publication
(10) Pub. No.: US 2010/0241956 A1
(43) Pub. Date: Sep. 23, 2010

(54) Information Processing Apparatus and Method of Controlling Information Processing Apparatus

(76) Inventors: Kyohei Matsuda, Ome-shi (JP); Tomoyuki Kokubun, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/726,217

(22) Filed: Mar. 17, 2010

(30) Foreign Application Priority Data
Mar. 18, 2009 (JP) 2009-066642

(51) Int. Cl. G06F 3/01; G06F 3/033

(52) U.S. Cl. 715/702; 715/863

(57) ABSTRACT

According to one embodiment, an information processing apparatus includes a touch panel comprising a display unit comprising a display screen and a touch sensor provided on the display screen and configured to output detection signals indicating touched positions on the display screen, a mode setup module configured to set a hovering mode when a one detection signal of the detection signals indicates an inside position of a hovering mode area set on the display screen, and an event output module configured to output a one position event based on an another detection signal to a one program which controls a window displayed at the outside position of the display screen when the hovering mode is set and the another detection signal of the detection signals indicates an outside position of the hovering mode area.

### CROSS-REFERENCE TO RELATED APPLICATIONS

This application is based upon and claims the benefit of priority from Japanese Patent Application No. 2009-066642, filed Mar. 18, 2009, the entire contents of which are incorporated herein by reference.

### BACKGROUND

1. Field

One embodiment of the invention relates to an information processing apparatus comprising a touch panel, and a method of controlling the information processing apparatus.

2. Description of the Related Art

A recent notebook computer comprises a display, and a touch panel having a position detector provided on a display screen.

A position detector uses a resistive film, or employs an electromagnetic induction system. An event indicating a position and another event indicating depression of a mouse button are usually passed to an application program, which controls a window displayed at a position detected by a position detector.

However, if a mouse button is pressed at all times, it is inconvenient for an application program to recognize the depression of a mouse button. Therefore, a hovering mode is may be provided. In a hovering mode, only the event indicating a position is passed to an application program.

Jpn. Pat. Appln. KOKAI Publication No. 2000-122808 discloses a technique, in which a hovering icon for setting a hovering mode is provided on a display screen, and a hovering mode is set when the hovering icon is touched in a normal mode, and a hovering mode is held until the hovering icon is touched again.

In the above technique, the normal mode and hovering mode are switched by touching the hovering icon. Therefore, if a user is away from a computer for a while, a user may be difficult to know whether the current mode is normal or hovering.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a system configuration of an information processing apparatus according to a first embodiment of the invention;

FIG. 2 is an exemplary view showing that a hovering mode is set by touching a hovering mode area with a finger, and another area is touched with a finger;

FIG. 3 is an exemplary diagram showing switching of normal mode and hovering mode according to the first embodiment, and a configuration in which a button-down event is not passed to an application program drawing a mouse cursor, while a hovering mode is being set;

FIG. 4 is an exemplary flowchart of a procedure executed by a mode setup module for setting normal mode and hovering mode according to the first embodiment;

FIG. 5 is an exemplary flowchart of a procedure executed by an event handle module when a mouse event is passed according to the first embodiment;

FIG. 6 is an exemplary view showing that a hovering mode is set, and a tool chip is displayed;

FIG. 7 is an exemplary view showing that a hovering mode is set, and a dialogue balloon is displayed by a launcher program;

FIG. 8 is an exemplary view showing that a hovering mode is set, and a finger makes mouse gestures;

FIG. 9 is an exemplary view showing that a user sets a hovering mode by pressing a button, and touches a display screen with a finger;

FIG. 10 is an exemplary diagram showing switching of normal mode and hovering mode according to a second embodiment, and a configuration in which a button-down event is not passed to an application program drawing a mouse cursor, while a hovering mode is being set;

FIG. 11 is an exemplary flowchart of a procedure executed by a mode setup module for setting normal mode and hovering mode according to the second embodiment; and

FIG. 12 is an exemplary flowchart of a procedure executed by an event handle module when a mouse event is passed according to the second embodiment.

### DETAILED DESCRIPTION

Various embodiments according to the invention will be described hereinafter with reference to the accompanying drawings. In general, according to one embodiment of the invention, an information processing apparatus comprising: a display unit comprising a display screen; a touch panel comprising a touch sensor provided on the display screen and configured to output two detection signals indicating two touched positions on the display screen; a mode setup module configured to set a hovering mode when a detection signal of the detection signals indicates an inside position of a hovering mode area on the display screen, and configured to set a normal mode when the detection signals indicate outside positions of the hovering mode area; and an event output module configured to output position events based on the detection signals and button events related to depression of a button of a pointing device to programs which control windows displayed at positions on the display screen corresponding to the detection signals when the normal mode is set, and configured to output a one position event based on an another detection signal of the detection signals to a one program which controls a window displayed at a position indicated by the another detection signal when the hovering mode is set and the another detection signal indicates an outside position of the hovering mode area.

### First Embodiment

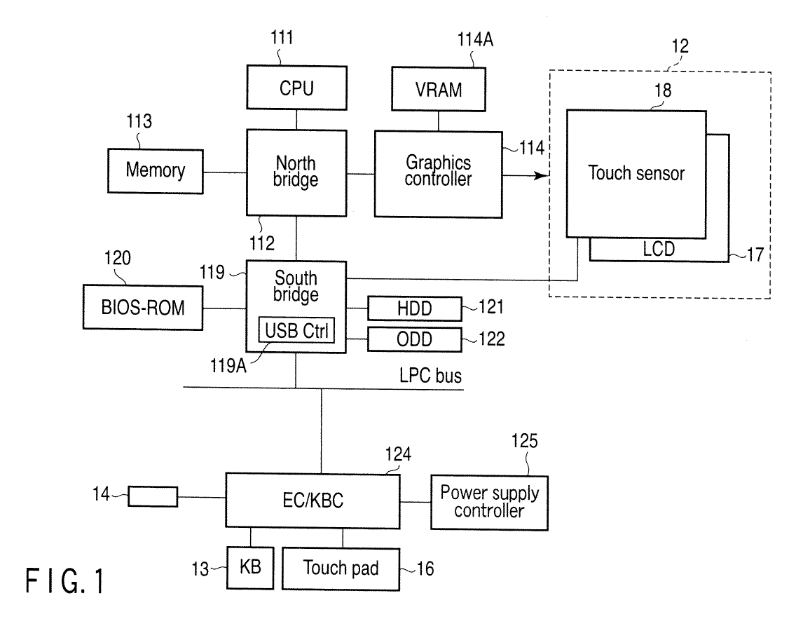

An information processing apparatus according to an embodiment of the invention will be explained first with reference to FIG. 1. The information processing apparatus is realized as a battery-powered notebook computer.

A system configuration of the computer will be explained by referring to FIG. 1.

As shown in FIG. 1, the computer comprises a display unit 12, a CPU 111, a north bridge 112, a main memory 113, a graphics controller 114, a south bridge 119, a BIOS-ROM 120, a hard disc drive 121, an embedded controller/keyboard controller IC 124, and a power supply controller 125.

The CPU 111 is a processor provided for controlling operations of the computer, and executes an operating system and application programs loaded from the hard disc drive 121 to the main memory 113.

The CPU 111 executes a BIOS program stored in the BIOS-ROM 120. The BIOS program is a program for controlling the hardware.

The north bridge 112 is a bridge device connecting a local bus of the CPU 111 to the south bridge 119. The north bridge 112 is provided with a memory controller for controlling access to the main memory 113. The north bridge 112 has a function of communicating with the graphics controller 114 through an AGP bus.

The display unit 12 is provided with a display comprising an LCD 17. A pressure-sensitive (resistive) touch sensor 18 is provided on the screen surface of the LCD 17. When the surface is touched, the touch sensor 18 outputs a detection signal indicating the touched position. The touch sensor 18 of this embodiment is configured to detect two positions at a time, and output two detection signals indicating the touched positions.

The graphics controller 114 is a display controller for controlling the LCD 17 used as a display monitor of the computer. The graphics controller 114 has a video memory 114A, and generates a video signal for forming an image to be displayed on the LCD 17 of the display unit 12, from data written into the video memory 114A by an OS/application program.

The south bridge 119 controls devices on the LPC bus. The south bridge 119 is provided with an IDE controller for controlling the hard disc drive 121. The south bridge 119 has a function for controlling access to the BIOS-ROM 120. The south bridge 119 is provided with a USB controller 119A for controlling data transmission with devices conforming the USB standard. The touch sensor 18 conforms to the USB standard, and performs data transmission with the USB controller 119A incorporated in the south bridge 119.

The embedded controller/keyboard controller IC 124 is a one-chip microcomputer incorporated with an embedded controller for managing power, and a keyboard controller for controlling a touch pad 16. The embedded controller/keyboard controller IC 124 cooperates with the power supply controller 125, and turns on/off the computer whenever a user presses a power button 14.

While the touch sensor 18 is outputting a detection signal, the operating system issues mouse events as events related to the button operation of a pointing device. The mouse events issued by the operating system are a position event indicating a position of a mouse cursor, and a button-down event indicating depression of a mouse button.

In operations with an ordinary mouse, when a pointer is placed on an icon on an explore or desktop, a tool chip indicating expanded information such as a file indicated by the icon is displayed.

However, in operations with a touch panel, the following inconvenience occurs. A button-down event is always issued at all times when a pointer is operated on a touch panel, and a tool chip cannot be displayed.

The embodiment apparatus can prevent such inconvenience. A configuration for preventing the inconvenience will be explained hereinafter.

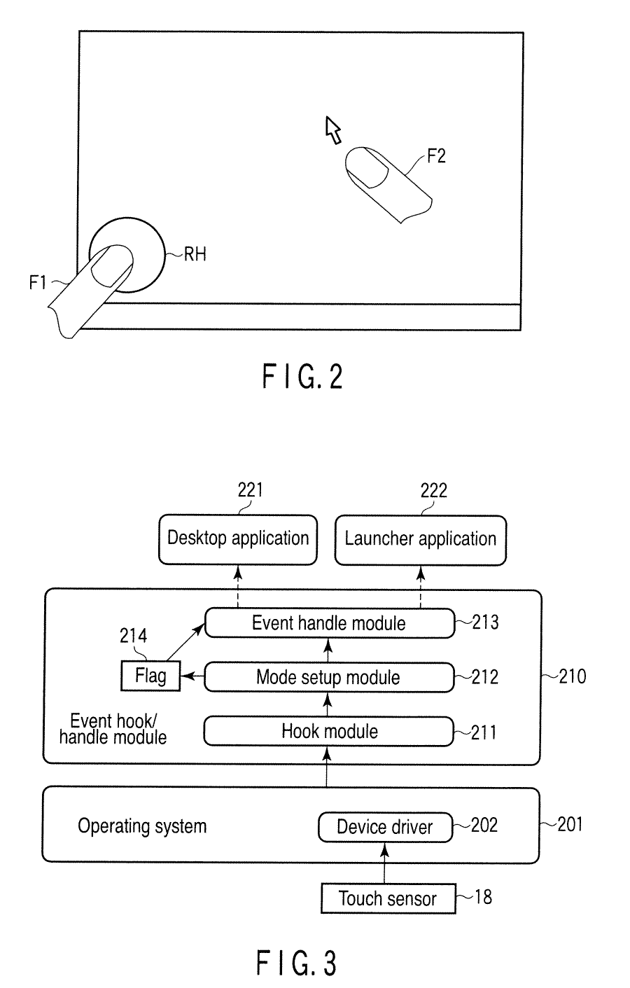

As shown in FIG. 2, a hovering mode area RH is set as an imaginary button at the left below corner of the display, for example. A hovering mode is set, when the touch sensor outputs a detection signal indicating that a finger F1 touches the hovering mode area RH. In the hovering mode, while the touch sensor is outputting a detection signal indicating that a finger F2 touches the other areas than the hovering mode area RH, an event related to the mouse button operation is not passed to an application program drawing a mouse cursor, and only an even indicating a mouse cursor position is passed to the application program. A normal mode is set, when the finger F2 does not touch the hovering mode area RH. In the normal mode, an event indicating the mouse button operation and mouse cursor position is passed to an application program drawing a mouse cursor.

Referring to FIG. 3, an explanation will be given of switching of normal mode and hovering mode, and a configuration in which a button-down event is not passed to an application program drawing a mouse cursor, while a hovering mode is being set.

The configuration shown in FIG. 3 comprises an operating system 201, a device driver 202, and an event hook/handle module 210.

The device driver 202 uses the same driver as the device driver of the ordinary touch sensor 18. Therefore, the device driver 202 obtains position information indicating a touched position from the touch sensor 18. The device driver 202 passes the position information to the operating system 201. The operating system 201 operates for passing a mouse event including a position event and a button-down event to an application program displayed at the position indicated by the position information (a desktop application 221, or a launcher application 222). The desktop application 221 is a window control means for displaying a desktop screen as one of windows on the display screen. The launcher application 222 is a window control means for displaying a window having buttons to start applications on a desktop screen.

The event hook/handle module 210 comprises a hook module 211, a mode setup module 212, and an event handle module 213. The hook module 211 hooks a position event and a button-down event output from the device driver 202. The mode setup module 212 switches a hovering mode and a normal mode based on a position indicated by a position event on the display screen. The event handle module 213 passes a position event and button-down event to a destination application program, in the normal mode. The event handle module 213 passes only a position event to a destination application program, in the hovering mode.

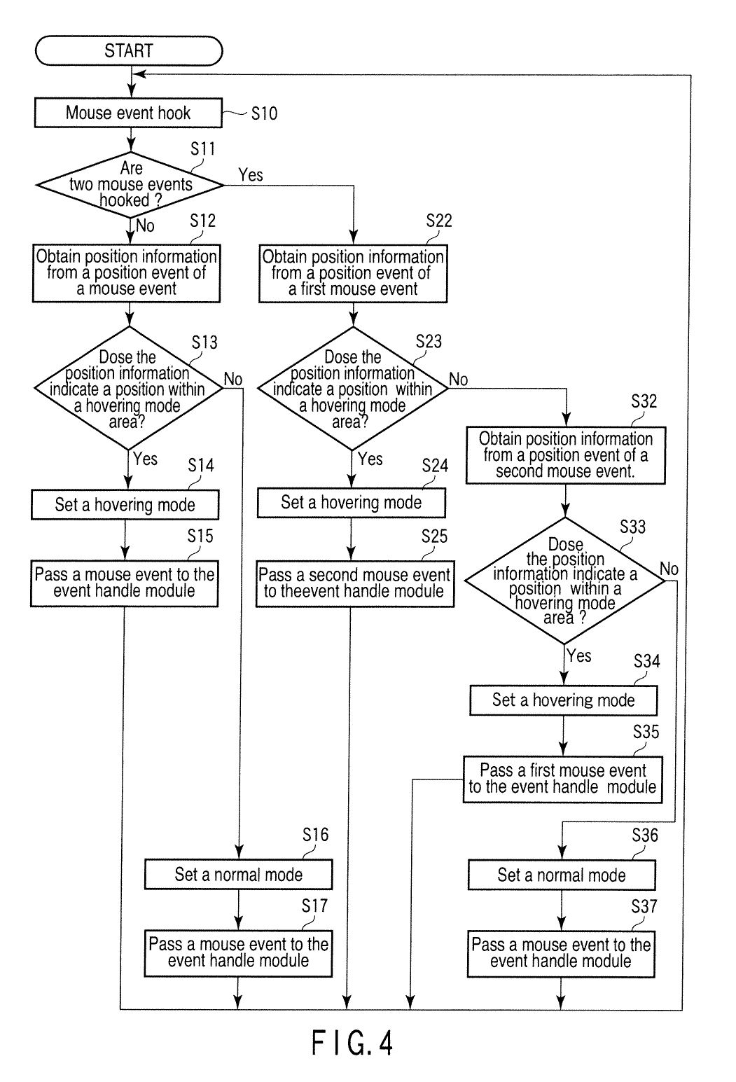

Next, an explanation will be given of a procedure executed by the mode setup module 212 for setting a hovering mode and a normal mode with reference to the flowchart shown in FIG. 4.

First, the hook module 211 hooks a position event and a button-down event (block S10). The mode setup module 212 determines whether these two mouse events are hooked (block S11). If the mouse events are not hooked two mouse events (No in block S11), the mode setup module 212 obtains position information indicating a position on the display screen from the position information of the mouse events (block S12). The mode setup module 212 determines whether the position information indicates a position within a hovering mode area RH (block S13). If the position information indicates a position within the hovering mode area RH (Yes in block S13), the mode setup module sets a hovering mode by making the value of a flag 214 true (block S14), and passes the mouse events to the event handle module 213 (block S15). If the position information does not indicate a position within the hovering mode area RH (No in block S13), the mode setup module 212 sets a normal mode by making the value of the flag 214 false (block S16), and passes the mouse events to the event handle module 213 (block S17).

In block S11, if two mouse events are hooked (Yes in block S11), the mode setup module 212 obtains position information indicating a position on the display screen from one of the events (a first mouse event) (block S22). The mode setup module 212 determines whether the position information indicates a position within the hovering mode area RH (block S23). If the position information indicates a position within the hovering mode area RH (Yes in block S23), the mode setup module 212 sets a hovering mode by making the value of the flag 214 true (block S24), and passes the other mouse event (a second mouse event) to the event handle module 213 (block S25).

If the position information does not indicate a position within the hovering mode area RH (No in block S23), the mode setup module 212 obtains position information indicating a position on the display screen from a second mouse event (block S32). The mode setup module determines whether the position information indicates a position within the hovering mode area RH (block S33). If the position information indicates a position within the hovering mode area RH (Yes in block S33), the mode setup module sets hovering mode by setting the value of the flag 214 to true (block S34), and passes the first mouse event to the event handle module 213 (block S35).

In block S33, if the position information does not indicate a position within the hovering mode area RH (No in block S33), the mode setup module 212 sets a normal mode by making the value of the flag 214 false (block S36), and passes the mouse event to the event handle module 213 (block S37).

The above completes the procedure executed when the hook module 211 obtains a mouse event. When a user touches a position within the hovering mode area RH, a user can set a hovering mode.

As a hovering mode is set when a user touches a position in the hovering mode area RH, and a normal mode is set when a user does not touch a position in the hovering mode area RH, a user can confirm which mode is being set.

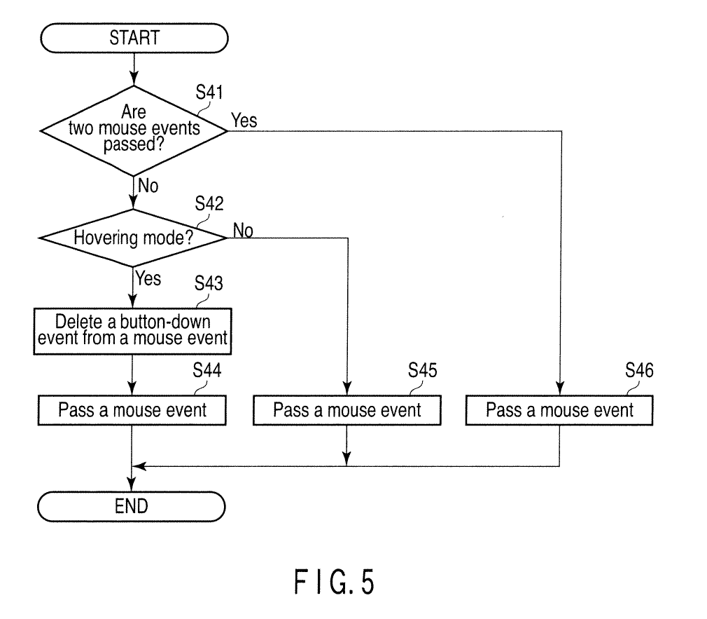

Next, an explanation will be given of a procedure executed by the event handle module 213 when a mouse event is passed, with reference to the flowchart shown in FIG. 5.

When a mouse event is passed, the event handle module 213 determines whether two mouse events are passed (block S41). If two mouse events are not passed (No in block S41), the event handle module 213 refers to the value of the flag 214, and determines whether a hovering mode is set according to the value (true or false) of the flag 214 (block S42). If a hovering mode is set (Yes in block S42), the event handle module 213 deletes a button-down event from a mouse event, leaves only a position event (block S43), and passes the mouse event with a button-down event deleted, to an application program that is a destination of the mouse event (block S44).

In block S42, if a hovering mode is not set (No in block S42), the event handle module 213 does not change the mouse event, and passes the mouse event to the destination application program (block S45). In block S41, if two mouse events are passed (Yes in block S41), the event handle module 213 passes the mouse events to an application program that is a destination of the mouse events (block S46).

By the above procedure, a mouse event issued by a general-purpose device driver in a hovering mode can be changed to a mouse event with a button-down event deleted.

There are following advantages when a hovering mode is set.

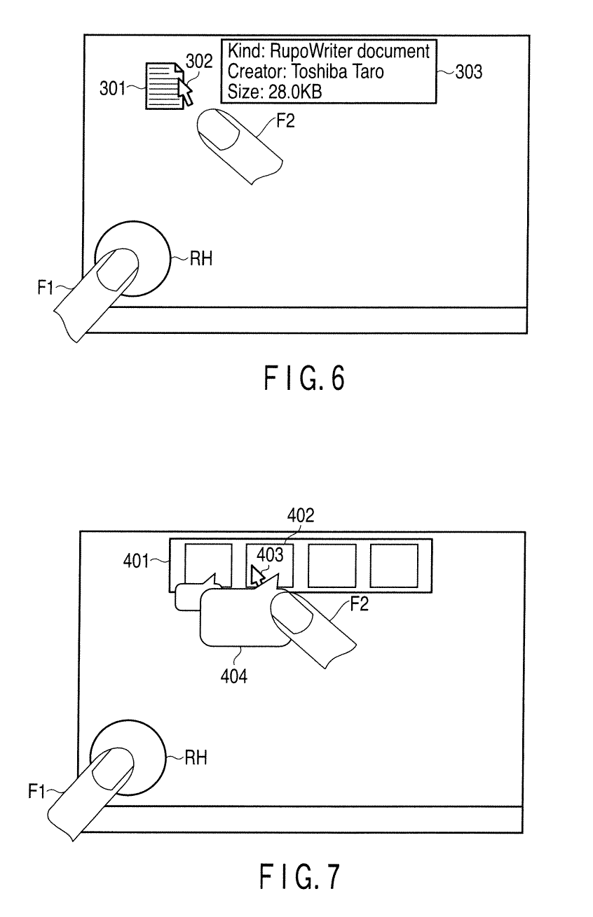

For example, as shown in FIG. 6, a hovering mode is set by touching a position within a hovering mode area RH on the display screen with a finger F1, and a mouse cursor 302 is placed on an icon 301 on the desktop screen by touching a finger F2. Then, a tool chip 303 showing the information of the file indicated by the icon 301 can be displayed.

As shown in FIG. 7, a hovering mode is set by touching a position within the hovering mode area RH on the display screen with a finger F1, and a mouse cursor 403 is placed on a button 402 in a window 401 displayed by a launcher program by touching a finger F2. Then, the information of an application program started by pressing the button 402 can be displayed in a dialogue balloon 404.

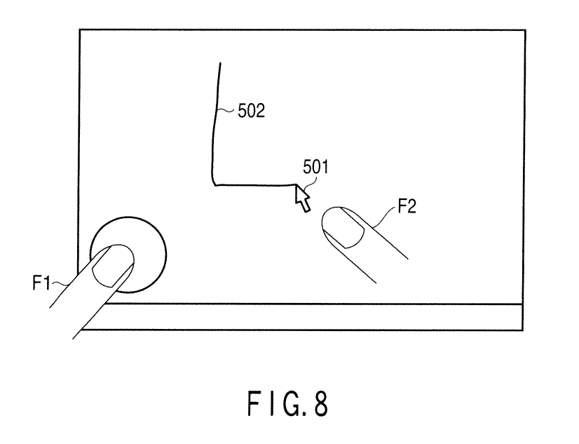

As shown in FIG. 8, a hovering mode is set by touching a position within the hovering mode area RH on the display screen with a finger F1, and a mouse gesture mode is added by moving a mouse cursor by touching a finger F2. Then, mouse gestures by hovering are possible. A line 502 displayed on the screen indicates the trace of a mouse cursor 501.

On a touch screen like a digitizer, hovering is realized by using a specifically designed pen. The same operation is possible with a finger in this apparatus. Windows® users familiar to mouse operations may be bothered when the users uses touch display whose main operations are “selection” by touch. If hovering function realizes the same operations as conventional mouse operating, the users will be release from bothersome. If a hovering function realizes the same operation as the conventional mouse, a user will be wide opened from troublesomeness.

### Second Embodiment

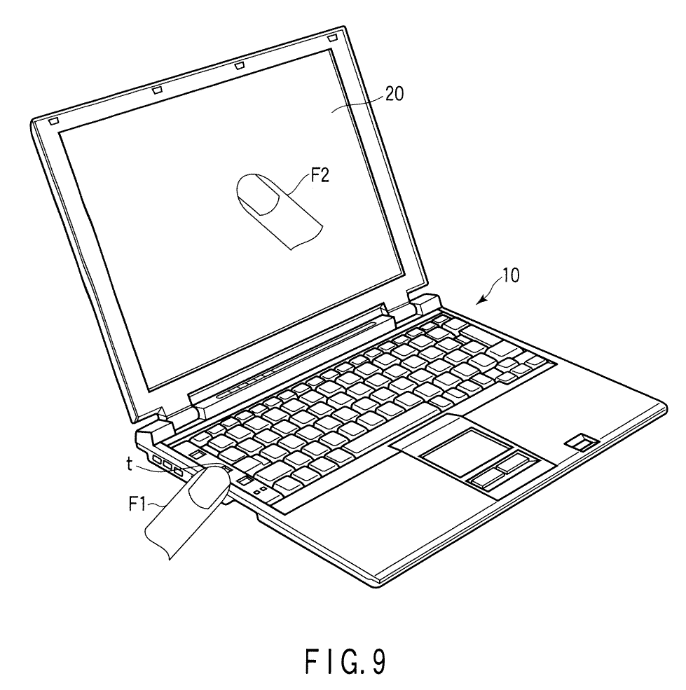

In stead of touching a position within the hovering mode area RH on the screen, a user may set a hovering mode by pressing a hovering mode button 601 provided on the main unit of a computer 10 with a finger F1, as shown in FIG. 9. A hovering mode may also be set by pressing a specific key (e.g., Alt key) on a keyboard 13, instead of pressing the hovering mode button 601. In FIG. 9, a display screen of the computer 10 is touched with a finger F2.

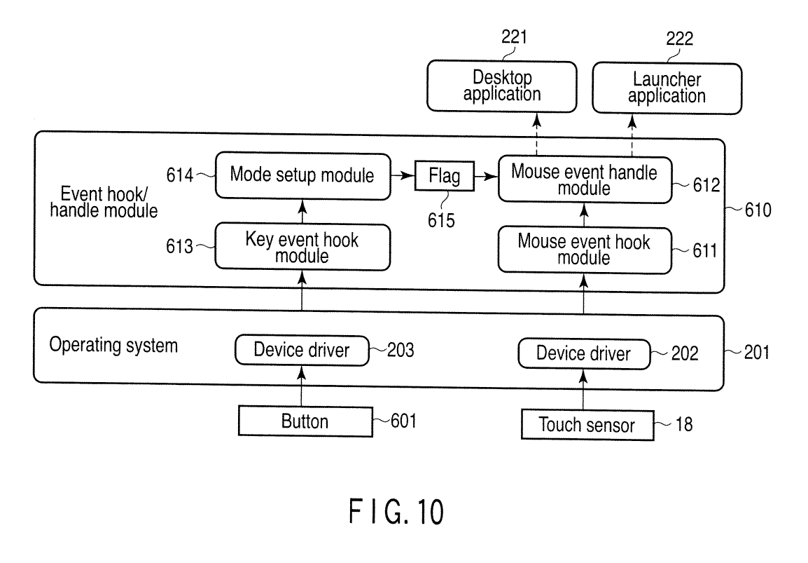

FIG. 10 shows a configuration of an event hook/handle module for setting a hovering mode by using the button 601.

The button 601 is a key for setting a hovering mode. A user can set a hovering mode by pressing the button 601. While the button 601 is not pressed, a normal mode is set.

The operating system 201 uses the same driver as a device driver for common keys.

As shown in FIG. 10, an event hook/handle module 610 comprises a mouse event hook module 611, a mouse event handle module 612, a key event hook module 613, a mode setup module 614, and a flag 615.

The mouse event hook module 611 hooks a mouse event issued by the operating system 201 for an application. The mouse event handle module 612 deletes a button-down event from a mouse event, and passes the mouth event including a position event to an application that is a destination of the event, in a hovering mode, as explained in FIG. 3.

The key event hook module 613 hooks a key event issued by the operating system 201, and passes it to the mode setup module 614. When the key event indicates depression of the button 601, the mode setup module 614 makes the value of the flag 615 true, and sets a hovering mode. When the key event does not indicate depression of the button 601, the mode setup module 614 makes the value of the flag 615 false, and sets a normal mode. When the key event is not received, the mode setup module 614 makes the value of the flag 615 false, and sets a normal mode.

Next, an explanation will be given of a procedure of setting the hovering mode and normal mode with reference to the flowchart shown in FIG. 11.

First, the mode setup module 614 determines whether a key event is received from the key event hook module 613 (block S51). If a key event is not received (No in block S51), the mode setup module makes the value of the flag 615 false, and sets a normal mode (block S54). If a key event is received (Yes in block S51), the mode setup module determines whether the key event indicates depression of the button 601 for setting a hovering mode (block S52). If the key event indicates the depression of the button 601 (Yes in block S52), the mode setup module makes the value of the flag 615 true, and sets a hovering mode (block S53). If the key event does not indicate the depression of the button 601 (No in block S52), the mode setup module makes the value of the flag 615 false, and sets a normal mode (block S53).

As a hovering mode is set when a user presses the button 601, and a normal mode is set when a user does not press the button 601, a user can confirm which mode is being set.

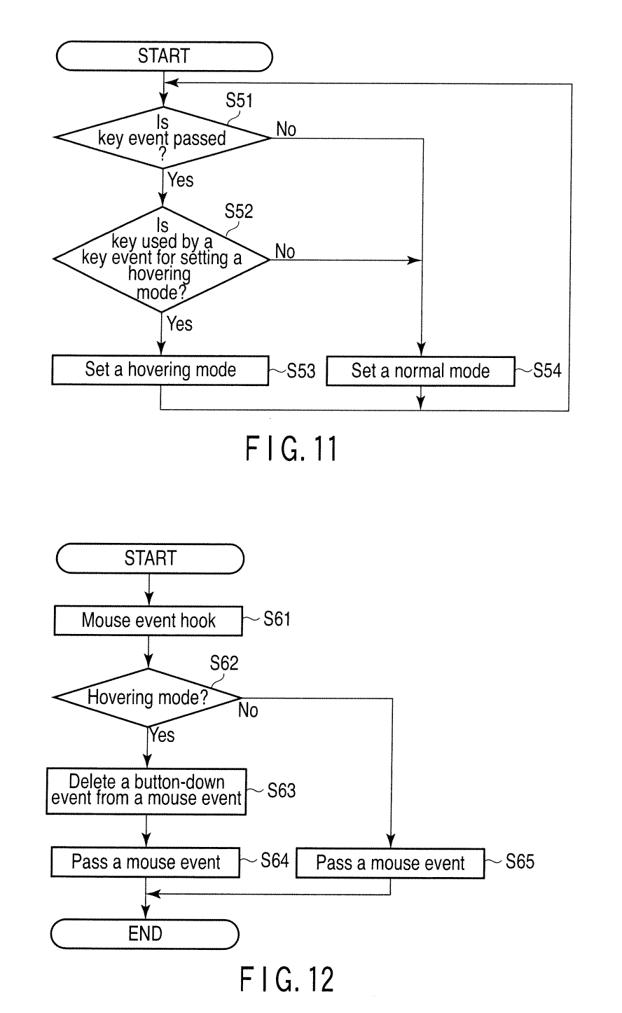

Next, an explanation will be explained of a procedure to be executed when the mouth event hook module 513 hooks a mouse event with reference to the flowchart shown in FIG. 12.

First, the mouse event hook module 513 hooks a mouse event (block S61). The mouse event hook module 513 passes the hooked mouse event to the mouse event handle module 612.

The mouse event handle module 612 refers to the value of the flag 615, and determines whether a hovering mode is set according to the value (true or false) of the flag 615 (block S62). If a hovering mode is set (Yes in block S62), the mouse event handle module 612 deletes a button-down event from the mouse event, and leaves only a position event (block S63). The mouse event handle module 612 passes the mouse event with the button-down event deleted to an application program that is a destination of the mouse event (block S64).

If a hovering mode is not set (No in block S62), the mouse event handle module 612 does not change the mouse event, and passes the mouse event to an application program that is a destination of the mouse event (block S65).

By the above procedure, a mouse event issued by a general-purpose device driver in a hovering mode can be changed to a mouse event not including a button-down event.

As explained hereinbefore, a hovering mode is set when a position within the hovering mode area on the display screen is touched, or when the button 601 is pressed. Therefore, a user can confirm which mode, hovering or normal, is being set.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display unit comprising a display screen;
a touch panel comprising a touch sensor provided on the display screen and configured to output two detection signals indicating two touched positions on the display screen;
a mode setup module configured to set a hovering mode when a detection signal of the detection signals indicates an inside position of a hovering mode area on the display screen, and configured to set a normal mode when the detection signals indicate outside positions of the hovering mode area; and
an event output module configured to output position events based on the detection signals and button events related to depression of a button of a pointing device to programs which control windows displayed at positions on the display screen corresponding to the detection signals when the normal mode is set, and configured to output a one position event based on an another detection signal of the detection signals to a one program which controls a window displayed at a position indicated by the another detection signal when the hovering mode is set and the another detection signal indicates an outside position of the hovering mode area.

2. The information processing apparatus of claim 1, wherein the event output module comprises:
a first event output module configured to output the position events based on the detection signals and the button events, regardless of the hovering mode and normal mode;
a hooking module configured to hook the position events and button events outputted from the first event output module; and
a second event output module configured to output the position events and the button events hooked by the hooking module to the programs when the normal mode is set, and to output the one position event hooked by the hooking module and indicating the outside position to the one program when the hovering mode is set.

3. The information processing apparatus of claim 1, wherein the one program is configured to display a desktop screen as the window.

4. The information processing apparatus of claim 1, wherein the one program is configured to display the window on a desktop screen.

5. An information processing apparatus comprising:
a touch panel comprising a display unit having a display screen and a touch sensor provided on the display screen and configured to output position information indicating a touch position on the display screen;
a mode setup key configured to output a key event for setting a hovering mode when the mode setup key is operated;
a mode setup module configured to set the hovering mode when the key event is output and to set a normal mode when the key event is not output; and
an event output module configured to output a position event based on the detection signal and a button event related to depression of a button of a pointing device to a program which controls a window displayed at a position on the display screen corresponding to the detection signal when the normal mode is set, and configured to output the position event to the program when the hovering mode is set.

6. The information processing apparatus of claim 5, wherein the mode setup key comprises a key specially designed for setting a hovering mode.

7. The information processing apparatus of claim 5, wherein the program is configured to display a desktop screen as the window.

8. The information processing apparatus of claim 5, wherein the program is configured to display the window on a desktop screen.

9. A method of controlling an information processing apparatus comprising a touch panel comprising a display unit comprising a display screen and a touch sensor provided on the display screen and configured to output two detection signals indicating two touch positions on the display screen, the method comprising:
setting a hovering mode when a one detection signal of the detection signals indicates an inside position of a hovering mode area set on the display screen;
setting a normal mode when the detection signals indicate outside positions of the hovering mode area; and
executing an event output process comprising outputting position events based on the detection signals and a button event related to depression of a button of a pointing device to programs which control windows displayed at outside positions on the display screen when the normal mode is set, and
outputting a one position event based on an another detection signal of the detection signals to a one program which controls a window displayed at position indicated by the another detection signal when the hovering mode is set and the another detection signal indicates an outside position of the hovering mode area.

10. The method of controlling an information processing apparatus of claim 9, wherein the event output process comprises:
outputting the position events based on the detection signals and the button events, regardless of the hovering mode and normal mode;
hooking the position events and button events;
outputting the hooked position events and hooked button events to the programs when the normal mode is set; and
outputting the one position event which is a one hooked position event of the hooked position event and indicates the outside position to the one program when the hovering mode is set.
